(19) United States
(12) Patent Application Publication
(10) Pub. No.: US 2026/0354577 A1
(43) Pub. Date: Nov. 12, 2026

(54) ROTARY STORAGE TRAY FOR CABINETS

(71) Applicant: SUN CHAIN TRADING CO., LTD., TAIPEI CITY (TW)

(72) Inventor: HSIN-TZU YAO, TAIPEI CITY (TW)

(21) Appl. No.: 19/243,707

(22) Filed: Jun. 20, 2025

(30) Foreign Application Priority Data
May 10, 2025 (DE) 20 2025 102 583.3

(51) Int. Cl. A47B 49/00; A47B 46/00

(52) U.S. Cl. CPC A47B 49/004; A47B 46/00

(57) ABSTRACT

A rotary storage tray for cabinets includes a fixed base, a turntable, and a storage tray. The fixed base is mounted on the bottom in the cabinet, a long-strip limit slot is provided at the center of the fixed base, a first rotary shaft is located near the mounting edge, the turntable is engaged to the fixed base, the center of the bottom of the turntable is provided with a second rotary shaft and a special-shaped slide slot, the first rotary shaft is movably installed in the special-shaped slide slot, and the second rotary shaft is movably installed in the limit slot. By rotational limited sliding of the first rotary shaft along the special-shaped slide slot, and linear limited sliding of the second rotary shaft along the limit slot, various objects can be taken out or returned to their original positions through a 360-degree rotation.

### CROSS-REFERENCE TO RELATED APPLICATIONS

This non-provisional application claims priority under 35 U.S.C. § 119(a) on Patent Application No(s). 20 2025 102 583.3 filed in German on May 10, 2025, the entire contents of which are hereby incorporated by reference.

### BACKGROUND OF THE DISCLOSURE

### Technical Field

The present disclosure relates to the technical field of slide rail accessories, and particularly relates to a rotary storage tray for cabinets, which utilizes a turntable with a special-shaped slide slot and a second rotary shaft, and a fixed base with a limit slot and a first rotary shaft. After the turntable and the fixed base are engaged, the first rotary shaft is movably arranged in the special-shaped slide slot and the second rotary shaft is movably arranged in the limit slot, and the turntable and the fixed base are installed in the cabinet, so that various objects can be placed on the rotary storage tray, and the objects located in different directions can be taken out by pulling them out and returned to their original positions through a 360-degree rotation to improve the convenience of use.

### Description of the Related Art

In general, a cabinet used in a kitchen is mostly used to store various seasonings or food containers. However, there is a certain distance between the inner space of the cabinet and the opening, and it is often inconvenient for users to take or place the items they need, so that a turntable for the cabinet is adopted. Most of these turntables adopt a design with a pivot and a slide rail, so the turntable can be moved from the inner space of the cabinet to the outside of the cabinet through the slide rail, and then rotated using the pivot, so as to allow users to take or place objects on the turntable, and put the turntable into the inner space.

To avoid wasting internal space and to prevent the periphery of the turntable from being unable to move out by rotation due to its contact with the inner wall of the cabinet during the rotation process, more connecting rods are often designed to change the rotation track, so that the turntable can be rotated out without hindrance. As a result, the design of the existing turntable structure is too complicated. Through the pivot and linkage of various components, the user can pull the turntable in a horizontal direction, and the storage tray can be rotated to a certain extent during the horizontal movement. After the above-mentioned complex rotation relationship, the storage tray can be rotated out without hindrance. In related-art turntable designs, there are too many components and too complicated structures, which require more manpower, material resources and time for manufacturing and assembly, thus reducing production efficiency. Therefore, how to effectively simplify the structure and reduce the number of components to improve production efficiency is what all manufacturers are eager to improve.

Furthermore, the conventional turntable mechanism design also has some disadvantages in use. For example, when the turntable is driven to move horizontally or rotate by the connecting rod structure, it is very likely to be deformed due to excessive load, and the supporting force is obviously insufficient to cause an angle tilt, thereby causing an unsmooth slide of the storage tray and even a malfunction. In view of this drawback, the discloser of the present disclosure based on years of manufacturing and production experience to conduct research and development, and finally developed a rotary storage tray for cabinets, to improve the aforementioned drawback. The rotary storage tray for cabinets uses a turntable with a special-shaped slide slot and a second rotary shaft, and a fixed base with a limit slot and a first rotary shaft. After they are assembled, the first rotary shaft is movably arranged in the special-shaped slide slot and the second rotary shaft is movably arranged in the limit slot, and the rotary storage tray is installed in the cabinet, so that various objects can be placed on the rotary storage, and the objects located in different directions can be taken out and returned to their original positions through a 360-degree rotation, so as to improve the convenience of use.

### SUMMARY OF THE DISCLOSURE

The primary objective of the present disclosure is to provide a rotary storage tray for cabinets, the rotary storage tray includes a fixed base, a turntable and a storage tray, wherein the center of the fixed base is provided with a long-strip limit slot and a first rotary shaft near the edge, the turntable is mounted on a surface of the fixed base, the center of the bottom of the turntable is provided with a second rotary shaft and a special-shaped slide slot with a closed surrounding design, the first rotary shaft is movably arranged in the special-shaped slide slot and the second rotary shaft is movably arranged in the limit slot, the first rotary shaft is used to perform rotational limit sliding along the special-shaped slide slot, and the second rotary shaft is used to perform linear limit sliding along the limit slot, so as to allow various objects to be placed on the storage tray, and taken out in different directions by a 360-degree rotation and or returned to their original positions, not only greatly simplifying the components and reducing the assembly and manufacturing costs, but also improving the convenience of use.

To achieve the aforementioned objective, the present disclosure discloses a rotary storage tray for cabinets, which is installed in a cabinet, for placing various objects on the storage tray, and accessing the objects in different directions through a 360-degree rotation, and the rotary storage tray for cabinets includes: a fixed base, being a rectangular sheet structure, the front edge of the fixed base corresponding the cabinet to form a mounting edge which is provided to be installed to the bottom in the cabinet, such that the mounting edge is located on a side of the front of the cabinet, and the center of the fixed base being provided with a long-strip limit slot, such that the extending direction of the limit slot is perpendicular to the mounting edge, and a position near the mounting edge is provided with a first rotary shaft;
a turntable, engaged with and installed to a side of the fixed base, and the center of the bottom of the turntable being provided with a second rotary shaft, and a special-shaped slide slot with a closed-surrounding design, for movably installing the first rotary shaft in the special-shaped slide slot and movably installing the second rotary shaft in the limit slot; and
a storage tray, fixedly mounted on the turntable, such that the storage tray rotates together with the turntable; such that when pulling the storage tray, the first rotary shaft can perform a rotational limit sliding along the special-shaped slide slot, and the second rotary shaft can perform a linear limit sliding along the limit slot, so as to allow the turntable to achieve a 360-degree rotation relative to the fixed base and to be pulled out. It is noteworthy that the first rotary shaft and the second rotary shaft are bearing roller structures.

In an embodiment of the present disclosure, the rotary storage tray for cabinets further includes two wing plates extending from two sides of the fixed base respectively, and the pair of wing plates are located at the mounting edge for facilitating the positioning and installation to the bottom of the front of the cabinet. In addition, the special-shaped slide slot of the present disclosure is formed of a pair of first curved parts with smaller curvatures and a pair of second curved parts with larger curvatures, so that the turntable can generate unequal distance translation motions when the first rotary shaft passes through the first curved parts and the second curved parts, and a cornering part is formed at the junction of the first curved parts and the second curved parts, so that the first rotary shaft can drive the turntable to rotate at a certain angle when passing through any of the cornering parts. In addition, when the turntable of the present disclosure performs a translational motion, the length of the limit slot corresponds to the outward translation distance of the turntable.

In another embodiment of the present disclosure, the rotary storage tray for cabinets further includes a plurality of heightening blocks provided on the bottom surface of the turntable and attached with the fixed base, for reducing the contact area between the turntable and the fixed base, and making the operation of the turntable smoother.

### BRIEF DESCRIPTION OF THE DRAWINGS

FIG. 1 is a first exploded view of a preferred embodiment of the present disclosure;

FIG. 2 is a second exploded view of a preferred embodiment of the present disclosure;

FIG. 3 is a perspective view showing the assembly of a preferred embodiment of the present disclosure;

FIG. 4 is a schematic view showing a first operating status of a preferred embodiment of the present disclosure;

FIG. 5 is a schematic view showing a second operating status of a preferred embodiment of the present disclosure; and

FIG. 6 is a schematic view showing a third operating status of a preferred embodiment of the present disclosure.

### DESCRIPTION OF THE PREFERRED EMBODIMENTS

The following description together with the attached drawings are provided to enable our examiner to clearly understand the technical contents of the present disclosure.

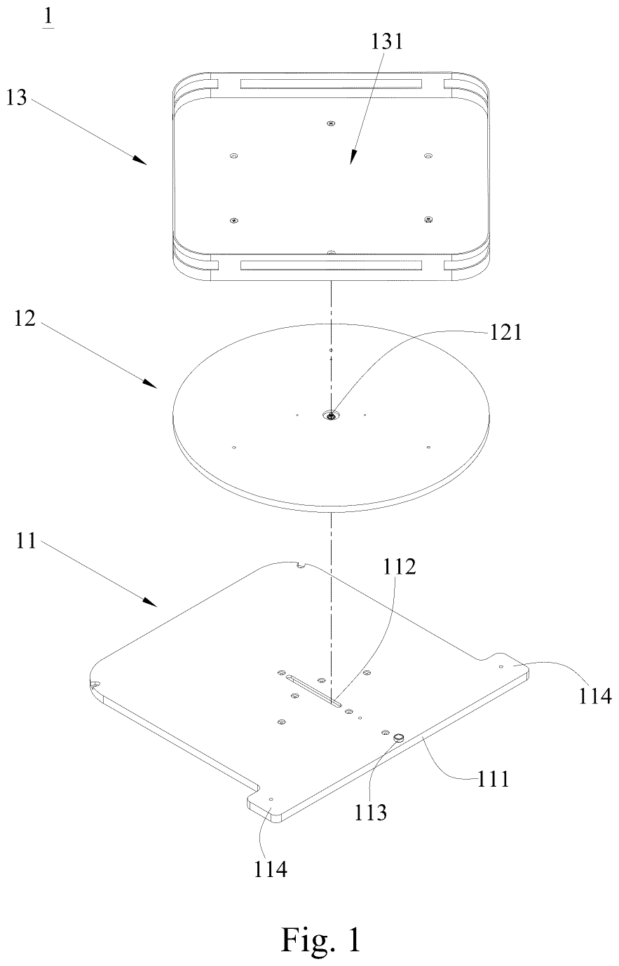

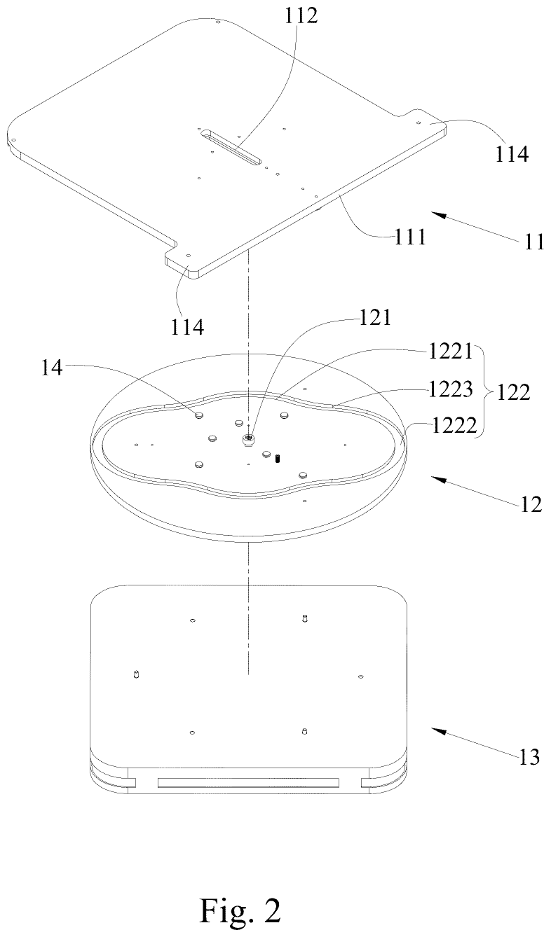

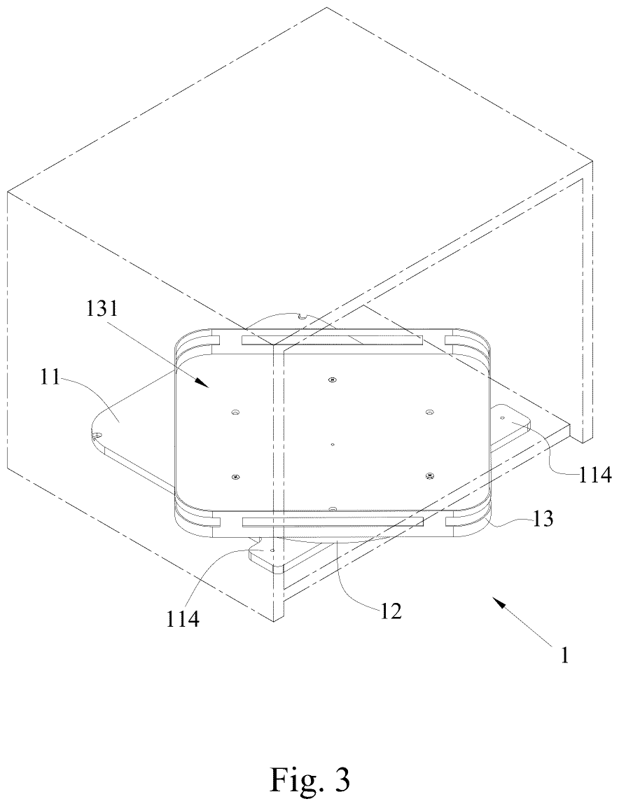

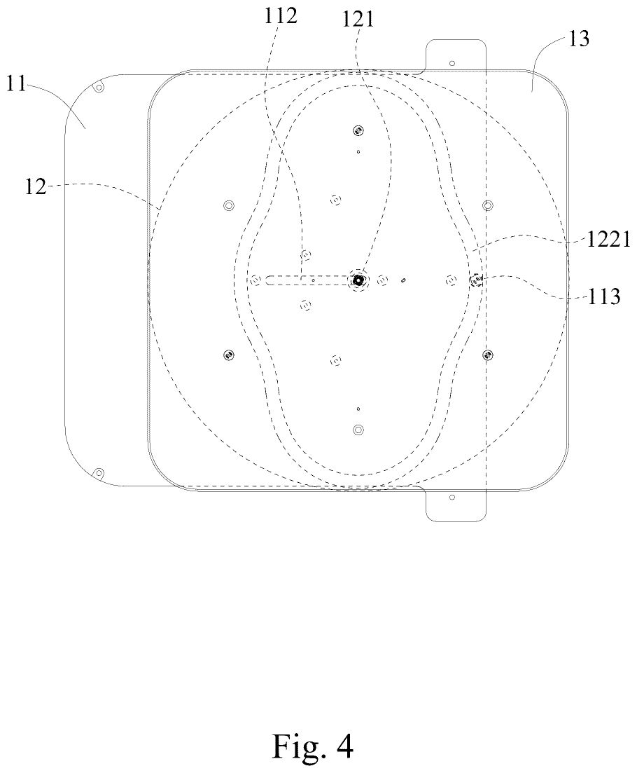

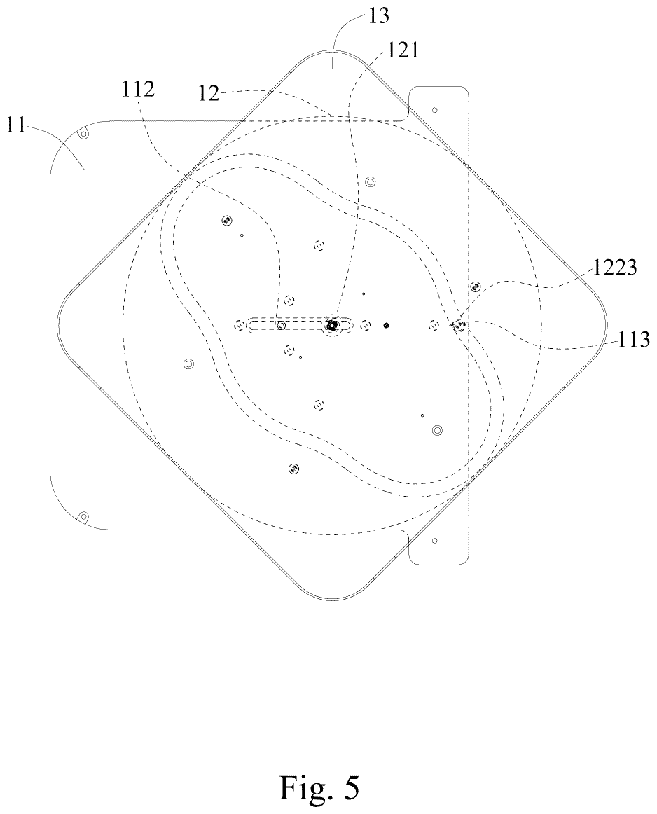

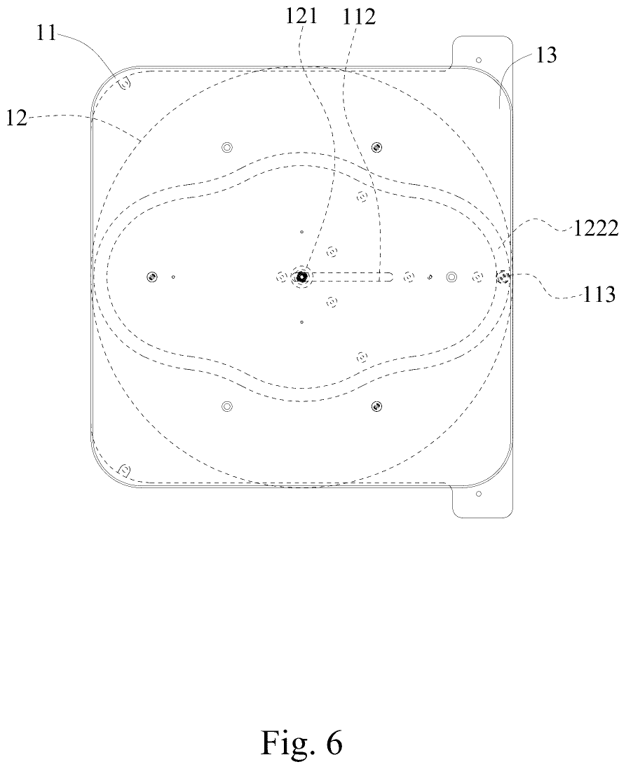

With reference to FIGS. 1, 2, 3 and 4 to 6 for the first and second exploded views, the perspective view, and the schematic views showing three different operating statuses of a rotary storage tray for cabinets in accordance with the preferred embodiment of the present disclosure respectively, the rotary storage tray 1 is installed in a cabinet 2 and provided for placing various objects on the rotary storage tray, the objects located in different directions can be taken out by pulling them out and returning them to their original positions through a 360-degree rotation, and the rotary storage tray 1 includes a fixed base 11, a turntable 12, and a storage tray 13.

The fixed base 11 is a rectangular sheet structure, and the front edge of the fixed base 11 corresponds to the cabinet 2 to form a mounting edge 111 for installation on the bottom surface of the cabinet 2, so that the mounting edge 111 is located on the a side of the front of the cabinet 2, and a limit slot 112 in the shape of a long strip is provided at the center of the fixed base 11, so that the extension direction of the limit slot 112 is perpendicular to the mounting edge 111, and a first rotary shaft 113 is provided near the mounting edge 111. It is noteworthy that the rotary storage tray 1 of the present disclosure further has two wing plates 114 extending from two sides of the fixed base 11 respectively, so that the pair of wing plates 114 are aligned with and located at the mounting edge 111.

The turntable 12 is mounted on a surface of the fixed base 11, a second rotary shaft 121 is provided at the center of the bottom surface of the turntable 12, a special-shaped slide slot 122 with a closed surrounding design is provided, so that the first rotary shaft 113 is movably arranged in the special-shaped slide slot 122, and the second rotary shaft 121 is movably arranged in the limit slot 112, wherein the first rotary shaft 113 and the second rotary shaft 121 are both roller bearing structures with a good lubrication effect, and can provide a smoother hand feeling during operation.

The storage tray 13 is fixedly mounted on the turntable 12, and a containing space 131 is formed on its top surface for placing objects therein, and the storage tray 13 can rotate together with the turntable 12.

In addition, the shape of the special-shaped slide slot 122 of the present disclosure is formed by a pair of first curved parts 1221 with a smaller curvature and a pair of second curved parts 1222 with a larger curvature, the shape is similar to that of a cloud, such that the turntable 12 can generate unequal distance translation motions when the first rotary shaft 113 passes through the first curved part 1221 and the second curved part 1222, and a cornering part 1223 is formed at the junction of the first curved part 1221 and the second curved part 1222, so that the first rotary shaft 113 can drive the turntable 12 to perform a rotational angle when passing through any of the cornering parts 1223, and when performing the translation motion, the second rotary shaft 121 is limited by the limit slot 112 to move in a predetermined distance. Therefore, when the turntable 12 performs the translational motion, the length of the limit slot 112 corresponds to the outward translation distance required by the turntable 12. Furthermore, the rotary storage tray 1 of the present disclosure further includes a plurality of heightening blocks 14 disposed on the bottom surface of the turntable 12 and attached to the fixed base 11, thereby reducing the contact area between the turntable 12 and the fixed base 11.

Based on the above, the rotary storage tray 1 of the present disclosure can be divided into the following two parts in practical applications. When pulling the storage tray 13, the first rotary shaft 113 can perform a rotational limit sliding along the special-shaped slide slot 122, and the second rotary shaft 121 can perform a linear limit sliding along the limit slot 112, so that the turntable 12 can achieve a 360-degree rotation relative to the fixed base 11 and can be pulled outward and returned to its original position after being pulled out. By rotating 360 degrees and pulling outward, objects in various directions can be quickly accessed, thereby achieving the purposes of simplifying components, reducing assembly and manufacturing costs, and improving the convenience of use.

What is claimed is:

1. A rotary storage tray installed in a cabinet for placing various objects therein, and taking out the various objects from different directions by pulling them out and returning them to their original positions through a 360-degree rotation, the rotary storage tray comprising:
a fixed base being a rectangular sheet structure, a front edge of the fixed base corresponding to the cabinet to form a mounting edge which is provided to be installed to a bottom inside the cabinet, such that the mounting edge is located on a side of a front of the cabinet, and a center of the fixed base being provided with a long-strip limit slot, such that an extending direction of the long-strip limit slot is perpendicular to the mounting edge, and a position near the mounting edge is provided with a first rotary shaft;
a turntable engaged with, and installed to, a side of the fixed base, and a center of a bottom of the turntable being provided with a second rotary shaft and a special-shaped slide slot with a closed-surrounding design for movably installing the first rotary shaft in the special-shaped slide slot and movably installing the second rotary shaft in the long-strip limit slot; and
a storage tray fixedly mounted on the turntable such that the storage tray rotates together with the turntable, wherein
when pulling the storage tray, the first rotary shaft is capable of performing rotational limit sliding along the special-shaped slide slot, and the second rotary shaft is capable of performing linear limit sliding along the long-strip limit slot, so as to allow the turntable to achieve a 360-degree rotation relative to the fixed base and to be pulled out.

2. The rotary storage tray for cabinets according to claim 1, further comprising two wing plates extending from two sides of the fixed base, respectively, so that the two wing plates are located at the mounting edge.

3. The rotary storage tray for cabinets according to claim 1, wherein a shape of the special-shaped slide slot is formed by a pair of first curved parts with a smaller curvature and a pair of second curved parts with a larger curvature, so that the turntable is capable of generating unequal distance translation motions when the first rotary shaft passes through the pair of first curved parts and the pair of second curved parts, and
a cornering part is formed at a junction of the pair of first curved parts and the pair of second curved parts, so that the first rotary shaft is capable of driving the turntable to rotate at an angle when passing through any of the cornering parts.

4. The rotary storage tray for cabinets according to claim 3, wherein, when the turntable performs a translational motion, a length of the long-strip limit slot corresponds to an outward translation distance of the turntable.

5. The rotary storage tray for cabinets according to claim 1, further comprising a plurality of heightening blocks installed on the bottom of the turntable and attached to the fixed base, for reducing a contact area between the turntable and the fixed base.

6. The rotary storage tray for cabinets according to claim 1, wherein the first rotary shaft and the second rotary shaft are bearing roller structures.
